(19) United States
(12) Patent Application Publication
(10) Pub. No.: US 2024/0009770 A1
(43) Pub. Date: Jan. 11, 2024

(54) APPARATUS FOR DIRECT METAL DEPOSITION ADDITIVE MANUFACTURING

(71) Applicant: AmPro Innovations Pty Ltd, Notting Hill, Victoria (AU)

(72) Inventor: Benjamin Kyle Wilson, Notting Hill, Victoria (AU)

(21) Appl. No.: 18/036,233

(22) PCT Filed: Nov. 5, 2021
(86) PCT No.: PCT/AU2021/051309

§ 371 Date: May 10, 2023

(30) Foreign Application Priority Data
Nov. 10, 2020 (AU) 2020904097

(51) Int. Cl. B23K 26/342; B22F 10/25; B22F 10/22; B33Y 30/00; B22F 12/00; B33Y 40/20; B22F 10/66; B23K 9/04

(52) U.S. Cl. CPC B23K 26/342; B22F 10/25; B22F 10/22; B33Y 30/00; B22F 12/22; B22F 12/224; B33Y 40/20; B22F 10/66; B23K 9/044

(57) ABSTRACT

Apparatus for AM production includes a support platform mounted for motorized movement; a direct metal deposition system having a metal deposition head carried above the platform by a multi-axis robotic arm mounted adjacent the support platform and operable to move the deposition head relative to the platform in a three-axis co-ordinate system; and CPU providing integration of CNC operation of the deposition system in depositing successive superimposed layers of metal to build or repair a component. The CPU is operable to integrate movement of the support platform relative to the X-Y plane of the co-ordinate system and actuation of the robotic arm to adjust the deposition head along the Z-axis after each layer is deposited, with closed loop control whereby each successive layers replicate a respective slice of the component, or part, in accordance with a CAD description. The apparatus further includes a unit that enables physical properties of deposited metal to be varied by in situ forging/micro-rolling of each, or selected layers prior to deposition of the next layer.

### FIELD OF THE INVENTION

This invention relates to an apparatus for direct metal deposition additive manufacture for the production or repair of components, based on a layering technique for deposition by application of an arc or electromagnetic beam, or heating by induction, to melt a source of supplied metal, and to enable refinement and homogenisation of the grain structure of deposited metal.

### BACKGROUND TO THE INVENTION

A variety of direct metal deposition systems is used in additive manufacturing of components, in parallel with 3D metal printing by application of an electromagnetic beam to selectively melt regions of successively deposited layers of metal powder. The direct metal deposition systems include welding-based shaped metal deposition systems, in which wire or rod is melted to form a molten pool by an arc, as in tungsten inert gas (TIG), metal inert gas (MIG), or by a plasma or inductive heating. They also deposition systems in which blown metal powder is melted by an electromagnetic beam, such as a laser or electron beam, with direct laser deposition (DLD) being the more commonly employed.

Each of the direct metal deposition systems is well suited to selected applications. Some systems are better suited for applications for which finish to a net or near-net shape is required, with the blown powder systems being more appropriate for attaining such a finish. While all the systems enable more rapid build times than metal printing by selective melting of deposited powder layers, welding-based systems provide the fastest build times but their finish usually is best suited for prototype productions for which a machining or other operations can be used to attain a suitable finish. The blown powder deposition systems, particularly DLD systems, provide the best balance of build time and finish, such as to produce components finished to a net or near-net shape.

DLD in fact is one of the most used AM techniques. In DLD processes, as intimated, powders are blown into a molten pool created by a high-energy laser beam. Compared with the other laser powder bed fusion such as selective laser melting, DLD shows its advantage in the capability of building large-scale components for the aerospace industry without the working space limitation imposed by powder bed dimensions.

Ti-6Al-4V (Ti64) is the most commonly used titanium alloy in the world, and has been widely selected for the fabrication of aircraft and other engineering components by DLD. However, components produced from Ti64 by DLD tend to form large columnar grains along the building direction, as illustrated later herein, leading to the anisotropic mechanical properties along different directions of the fabricated parts. Another issue that limits the application of DLD technology is the random formation of defects or voids that can form randomly in use of the technology. Large components, such as Ti parts in aircrafts, are load-bearing components where fatigue life is critical, but defects and voids can lead to a dramatic reduction in fatigue life. This invention is aimed to refine and homogenise the grain structure and eliminate the defects/voids in the process.

The present invention seeks to provide improved apparatus for direct metal deposition additive manufacture for the production or repair of components, based on a layering technique for deposition using a selected one of the direct deposition systems. At least in preferred forms, the present invention aims to enable refinement and homogenisation of the grain structure of alloys used for components produced by direct metal deposition additive manufacture and a reduction or substantial elimination of the defects/voids in the components.

### BROAD DESCRIPTION OF THE INVENTION

According to a first aspect of the invention there is provided additive manufacturing apparatus for the production or repair of a components, wherein the apparatus includes a support platform on which a component is built or repaired, with the support platform mounted for motorized movement relative to a horizontally extending X-Y plane; a direct metal deposition system having a metal deposition head carried above the platform by a multi-axis robotic arm that is mounted adjacent to the support platform, wherein the robotic arm is operable to move the deposition head relative to the platform in a three-axis co-ordinate system having X- and Y-axes parallel to the horizontally extending plane and a Z-axis perpendicular to the horizontally extending plane; and wherein the apparatus further includes a central processing unit (CPU) providing integration of computer numerical control (CNC) operation of the direct deposition system in depositing successive superimposed layers of metal to build or repair a component, with the central control unit operable to integrate movement of the support platform relative to the horizontally extending X-Y plane and actuation of the robotic arm to adjust the deposition head parallel to the Z-axis and away from the support platform after each layer is deposited, as required for repetitive deposition of metal in successive layers each superimposed on a preceding layer, with the integration of operation in each case based on closed loop control with feedback monitoring whereby each successive deposited layer of metal replicates the form and dimensions of a respective successive slice of the component, or part of a component being repaired, in accordance with a 3D computer aided design (CAD) description of the component; and wherein the apparatus further includes a forging and/or micro-rolling (herein forging/micro-rolling) unit adapted to enable physical properties of deposited metal to be varied by in-situ forging/micro-rolling of each, or selected, layers prior to deposition of the next layer; the forging/micro-rolling unit including:
(a) an adjustment member adjustably mounted above the support platform for motorized movement of the adjustment member parallel to or in the direction of the Z-axis; and
(b) a forging/micro-rolling head depending below the adjustment member and including a forging/micro-rolling roller rotatable on an axis extending substantially parallel to the horizontally extending X-Y plane;
   with the arrangement such that, by varying the spacing of the adjustment member from the support platform, the forging/micro-rolling head is adjustable towards or away from the support platform, parallel to or in the direction of the Z-axis whereby, with use of the forging/micro-rolling unit, the forging/micro-rolling head can be positioned a distance from the support platform so that, as the support platform is moved relative to the X-Y plane to advance newly deposited metal in a layer in the course of being formed, the forging/micro-rolling head is operable to apply controlled rolling pressure progressively along a line of deposited metal. The apparatus, in effect, enables hybrid AM production, using an in-situ forging/micro-rolling head, with the CPU enabling synchronized in-site forging/micro-rolling, with deposited metal, which may be semi-molten, being pressed substantially simultaneously with deposition.

The apparatus most conveniently is contained within a housing that is either air-tight or maintained at a slight overpressure. When so contained the apparatus can operate in a controlled protective or inert atmosphere, or at least an atmosphere with a sufficiently low partial pressure of oxygen minimizing oxidation or fire risk.

The direct metal deposition system of the apparatus of the invention may be a welding-based shaped metal deposition system, in which wire, or rod is melted to form a molten pool by an arc. Preferred welding-based systems include tungsten inert gas (TIG), metal inert gas (MIG), laser or other systems in which wire, or rod is melted utilizing plasma, laser or inductive heating. Alternatively, the direct metal deposition system of the apparatus may be a deposition system in which blown metal powder is melted by an electromagnetic beam, such as a laser or electron beam, with direct laser deposition (DLD) being preferred.

The apparatus may include a basal structure above which the support platform is mounted and relative to which the support platform is movable. In one arrangement, the support platform is be movable linearly, such as parallel to one of the X- and Y-axes. In another arrangement, the support platform is mounted on a motorized upper carriage that is movable linearly parallel to one of the X- and Y-axes, with the upper carriage mounted on a motorized lower carriage that is movable linearly parallel to the other one of the X- and Y-axes. In each of these arrangements, the support platform may be motorized to be rotatable on an axis parallel to the Z-axis, such as in the manner of a turntable.

The use of a direct metal deposition system in the apparatus of the invention can be particularly beneficial where the microstructure of the metal used provides physical properties suitable for the end use of the component produced or repaired. Where this is not the case, enhancement of the properties may be achievable by a suitable heat treatment for the component. However, not all metals are heat treatable and, even with metals that are heat treatable, there can be constraints limiting the extent to which the metal formed by the layering technique of metal deposition can be heat treated for the purpose of achieving an improvement in physical properties. However, as indicated, the apparatus includes a unit that enables physical properties to be varied by in-situ forging/micro-rolling of each, or selected, layers prior to deposition of the next layer. In the context, the in-situ forging/micro-rolling of successive layers can be regarded as in-situ micro- or mini-forging/micro-rolling.

In the form the apparatus enabling in-situ forging/micro-rolling of each of at least selected layers in the course of metal being deposited, the apparatus includes a column that extends in the direction of the Z-axis to stand above and to one side of the support platform, with the column fixed in relation to a rigid base above which the support platform is positioned. Above the support platform, the forging/micro-rolling unit includes an adjustment arm comprising the adjustment member that extends laterally from the column, with the adjustment arm adjustably mounted on the column to enable motorized movement of the adjustment arm parallel to or in the direction of the Z-axis. The apparatus further includes a column that extends in the direction of the Z-axis to stand above and to one side of the support platform, with the column fixed in relation to a rigid base above which the support platform is positioned. An adjustment arm extends laterally from the column, with the adjustment arm adjustably mounted on the column to enable motorized movement of the adjustment arm parallel to or in the direction of the Z-axis. A forging/micro-rolling head depending below the adjustment arm and including a forging/micro-rolling roller rotatable on an axis extending substantially parallel to the horizontally extending X-Y plane. The forging/micro-forging/micro-rolling unit preferably includes a rod depending below the adjustment arm with the forging/micro-rolling head mounted at the lower end of the rod. The arrangement is such that, by varying the spacing of the adjustment arm from the support platform, the rolling head is adjustable towards or away from the support platform, parallel to or in the direction of the Z-axis. Thus, with use of the forging/micro-rolling unit, the forging/micro-rolling head is able to be positioned a distance from the support platform so that, as the support platform is moved relative to the X-Y plane to advance newly deposited metal in a layer in the course of being formed, the forging/micro-rolling head is able to apply controlled forging/micro-rolling pressure progressively along a line of deposited metal.

The deposition head most conveniently is near to the forging/micro-rolling head. Consequently, a weld pool formed adjacent to the deposition head, as well as the specific heat energy source for the chosen direct metal deposition system, will be correspondingly close to, and will tend to heat, the rolling head. If left unchecked, the temperature of the rolling head could increase progressively and lead to variation in the performance of the roller in effecting forging/micro-rollingforging/micro-rolling/micro-rolling of the deposited metal. In one form of the apparatus, the temperature of the rolling head is controlled by circulation of a cooling fluid, most conveniently water, through the rolling head. In an arrangement enabling this, the rolling head comprises a hollow roller that is secured at the lower end of the rod of the forging/micro-rolling unit by being journaled in the lower ends of depending arms of a yoke of the rolling head that is secured to the lower end of the rod. In that arrangement the roller may have a respective stub axle at each end that is rotatable in a respective arm of the yoke, and a respective connector projecting form the end of each stub axle to enable the roller to be connected in a fluid flow line to enable circulation of cooling fluid through the roller.

The forging/microrolling head most conveniently has a roller made of metal that, at the prevailing temperature at which forging/micro-rolling is to be conducted, is compatible with the metal being deposited and to be rolled. Suitable metals for the roller can include those having a composition the same as, or like, that being deposited, as well as other metals having a hardness value greater than that of the metal being deposited. However, the roller also is able to be of a suitable ceramic that is sufficiently thermally conductive as to be able to be used, if necessary with cooling, at a sufficiently stable temperature, with suitable ceramics including silicon carbide, tungsten carbide and boron nitride. The use of a ceramic is subject to reaction of the ceramic roller and the deposited, possibly semi-molted, metal being alleviated or eliminated or any reacted products imposing no detrimental effect to the deposited metal.

The overall structure formed by the base above which the support platform is positioned, and by the column, preferably is relatively fixed or rigid. The arrangement is such that, with increasing aggregate height of deposited layers of metal above the support platform, the height of the rolling head of the forging/micro-rolling unit is able to increase correspondingly by adjustment of the height of the laterally extending adjustment arm on the column. To enable this, the forging/micro-rolling unit includes a drive system by which the adjustment arm is movable on the column for movement of the adjustment arm in the direction of or parallel to the Z-axis. Operation of the drive system of the forging/micro-rolling unit most preferably is by means of the central control unit. Operation of the drive system may be to adjust the spacing of the rolling head from the support platform to achieve substantially uniform application of pressure by the rolling head throughout the deposition of metal during the production or repair of a component, or to vary the application of the pressure at selected stages of metal deposition during a production cycle.

The central control unit operates the direct metal deposition system by actuating the multi-axis robotic arm to position the metal deposition head as required for metal deposition. Throughout a required cycle for the production or repair of a component, the robotic arm may be actuated to maintain the deposition head at fixed coordinates relative to the X- and Y-axes, while adjusting the position of the deposition head parallel to the Z-axis, in synchronism with movement of the adjustment arm in the direction of the Z-axis, to allow for the progressive build-up of metal as successive layers are deposited. For the production cycle, the control unit actuates a feed mechanism providing a supply of feed metal to the deposition head, whether the feed metal is wire, rod or metal powder, while control unit also powers the deposition head to melt the metal for deposition and progression of a weld pool.

In positioning the deposition head, the central control unit can operate to maintain a weld pool in a deposition zone that is in close juxtaposition to the rolling head of the forging/micro-rolling unit. The arrangement preferably is such that the rolling head follows closely after the deposition head relative to the direction of metal deposition. Thus, as the support platform is moved relative to the X-Y plane, the support platform is moved under the deposition head such the deposited metal is drawn towards the rolling head and is progressively subjected to the action of the roller of the rolling head. The axis of the roller preferably is maintained perpendicular to a line along which the deposited metal is drawn towards the rolling head, such that the axis is substantially at right angles to a tangent where the line is curved. The spacing between the deposition head and the rolling head can vary with the metal being deposited and, hence, the temperature prevailing in the weld pool, and the rapidity with which the metal solidifies sufficiently. The support platform typically is of metal with which the metal being deposited can bond metallurgically, and the support platform and cooled preceding layers accordingly provides a heat sink assisting relatively rapid solidification of deposited metal. This enables the deposition head to be in a desirable close juxtaposition to the rolling head, such as with a spacing between the rolling head and the deposition head of from about 10 to 60 mm, preferably of from about 15 to 40 mm.

As indicated, the support platform may movable linearly, such as parallel to one of the X- and Y-axes. However, this essentially limits the apparatus to being able to deposit metal in linear strips, such as in successive layers each comprising one linear strip or a series of laterally adjacent linear strips. It therefore is preferred that the support platform is movable linearly parallel to each of the X- and Y-axes, with the support platform more preferably also rotatable on an axis parallel to the Z-axis in the manner of a turntable. However, for some applications, it can be sufficient for the support platform to be movable relative to the X-Y plane simply be the support platform being rotatable. Particularly with the support platform movable parallel to each of the X- and Y-axes, such as with the support platform also rotatable on an axis parallel to the Z-axis, it is preferred that the central control unit is able to cause the rod of the forging/micro-rolling unit to adjust and thereby enable the forging/microrolling head to move so the axis of rotation of the rolling head swings. Thus, the rod of the forging/micro-rolling unit may have an upper end portion rotatably journaled in the adjustment arm, with the central control unit operable to cause reversible rotation of the rod on an axis extending in the direction of or parallel to the Z-axis whereby the forging/micro-rolling rolling head is able to sweep substantially parallel to the horizontally extending X-Y plane through an angle sufficient to maintain the roller of the forging/micro-rolling head in a substantially constant positioning relative to the deposition head. The angle may be up to about 180° to enable the rolling head swing about 90° to either side of an a line along which the roller follows the deposition head for linear deposition of metal, such that the axis of rotation of the roller is able to extend radially with respect to a line of curved metal deposition.

At least under stable operating conditions, the forging/micro-rolling unit can enable substantially uniform rolling conditions through a production cycle of operation. However, the forging/micro-rolling unit may have a form that enhances substantially uniform rolling conditions or that enables variation, as required, of the rolling conditions. For this, the forging/micro-rolling unit may incorporate a pressure sensing device that monitors the pressure by which the rolling head is caused to bear against and roll the deposited metal. This allows the micro-forging/micro-rolling to be carried out under a constant load or constant height position regardless the variation of the hardness of the semi-molten metal. Thus, for example, the rod of the forging/micro-rolling unit, or the arm in which the upper end of the rod is mounted, may have an associated load cell operable to measure the load applied to the deposited metal. The load can be displayed on a visual display of the apparatus, such as with the option of manual adjustment of the load, or the load may be monitored by the central control system, with the central control system operable to vary the load. In each case, the load may be varied by the drive by which the arm of the forging/micro-rolling unit is adjustable along or parallel to the Z-axis.

### GENERAL DESCRIPTION OF THE DRAWINGS

To enable the invention to be understood more fully reference now is directed to the accompanying drawings, in which:

FIG. 1 is a perspective view of an installation housing apparatus according to an embodiment of the present invention;

FIG. 2 is a vertical sectional view of the installation, taken on line II-II of FIG. 1;

FIG. 3 FIG. 3 is a plan view of the installation of FIG. 1;

FIG. 4 shows the apparatus of the installation of FIG. 1, in a view corresponding to that of FIG. 2;

FIG. 5 shows the apparatus of the installation of FIG. 1, in a view corresponding to that of FIG. 3;

FIG. 6 shows the apparatus of the installation of FIG. 1, in a side elevation from the right-hand side of FIGS. 2 and 3;

FIG. 7 is a perspective view of the apparatus of the installation of FIG. 1 set up to produce a first form of component comprising a frame;

FIG. 8 shows part of the apparatus of FIG. 7, shown on an enlarged scale;

FIG. 9 corresponds to FIG. 7 but shows an alternative form of apparatus suitable for an installation as in FIG. 1, set up to produce a second form of component comprising a circular hub;

FIG. 10 shows part of the apparatus of FIG. 9, shown on an enlarged scale;

FIG. 11 shows enlarged detail from the view of FIG. 8;

FIG. 12 illustrates the close disposition of parts of the apparatus;

FIG. 13 shows a preferred tracking system in use of the apparatus;

FIG. 14 shows a preferred form for a part of the apparatus;

FIG. 15 is a low magnification photomacrograph obtained using a conventional DLD metal deposition of Ti6Al4V;

FIG. 16 shows photomicrographs obtained using apparatus utilizing a DLD metal deposition of Ti6Al4V (a) as produced without rolling and (b) as produced with rolling with a system based on the teaching in relation to the apparatus of the invention, and respective plots of grain size distribution (c) for micrograph (a) and (d) for micrograph (b); and

FIG. 17 shows tensile stress-strain curves for metal produced (a) by the system used for the photomicrograph of FIG. 15, and (b) and (c) by the system used for the photomicrograph of FIG. 16 with respective levels of in-situ forging/micro-rolling.

### DETAILED DESCRIPTION OF THE DRAWINGS

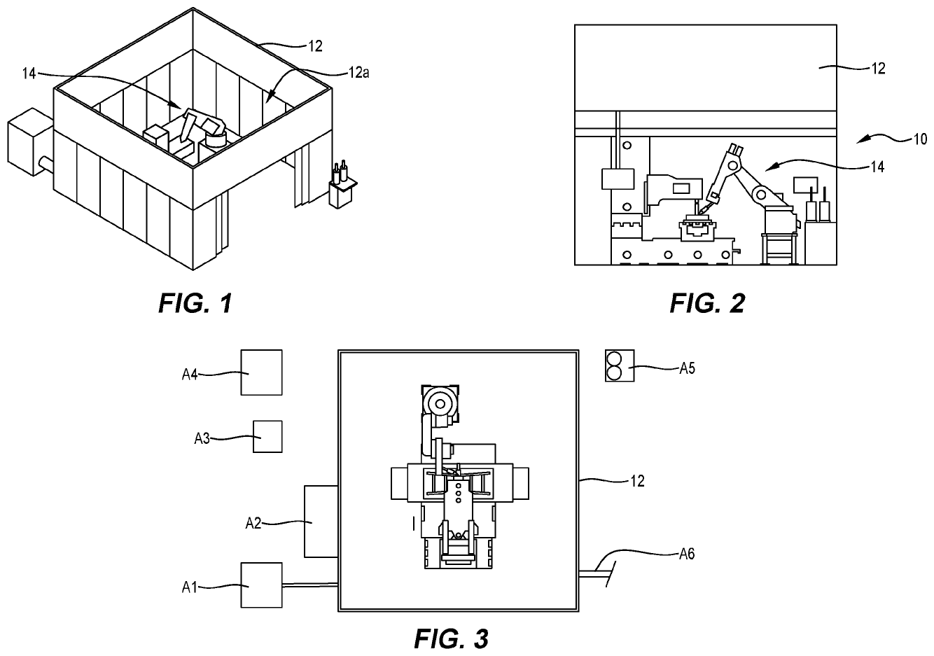

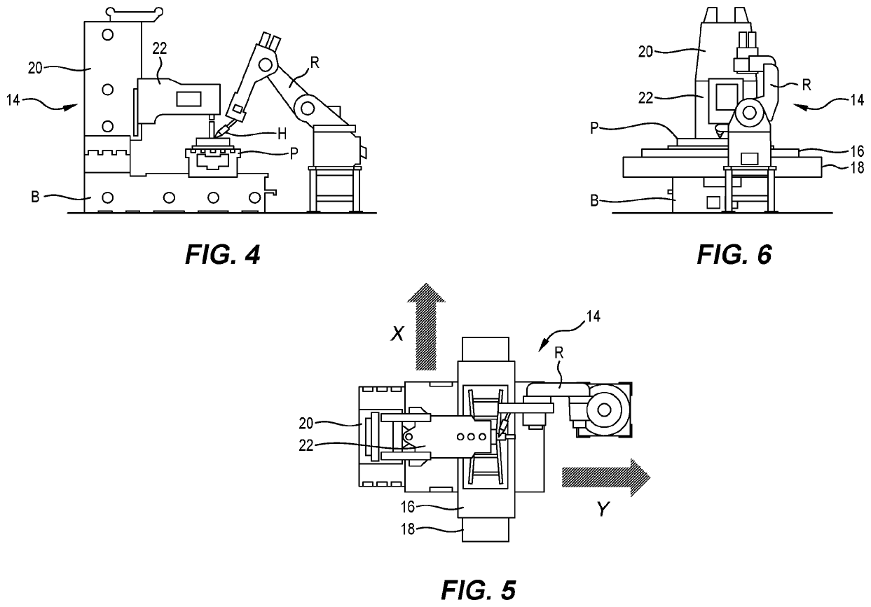

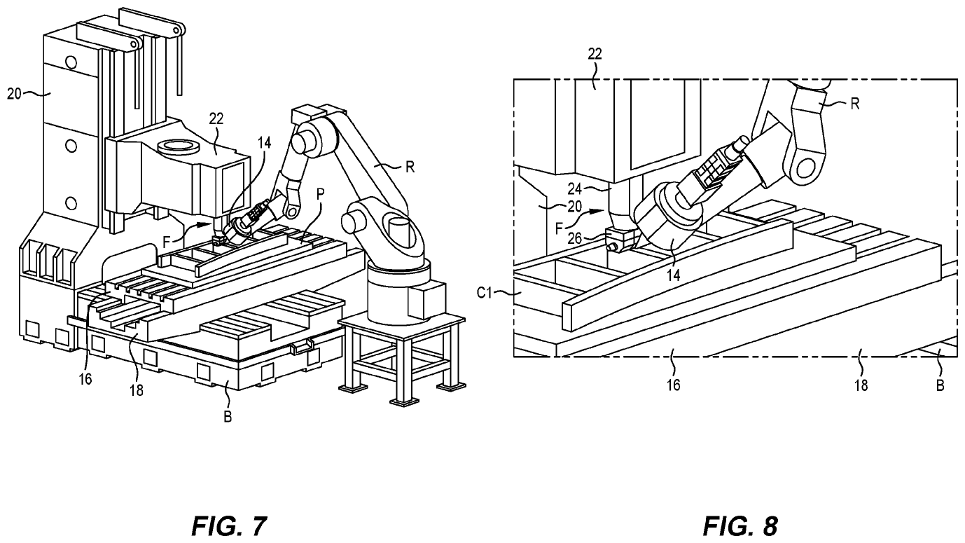

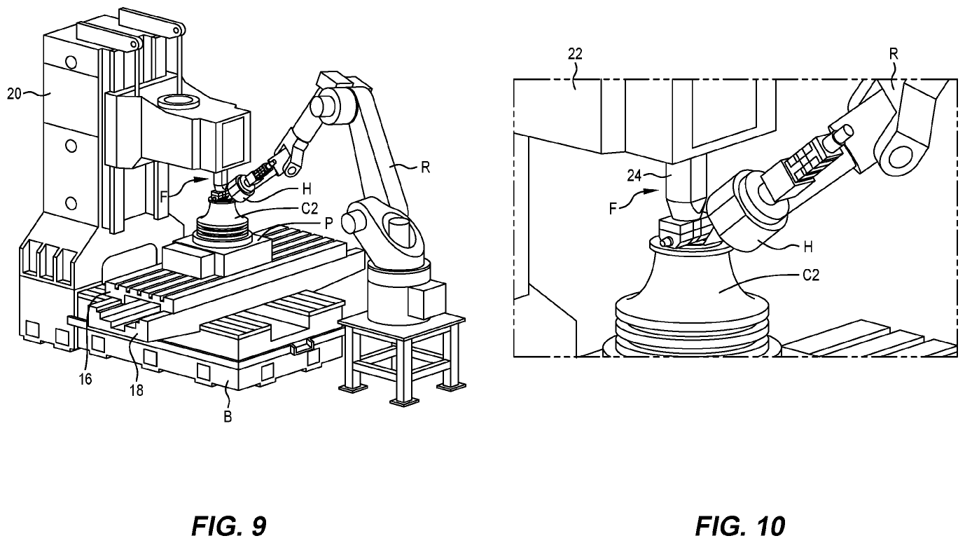

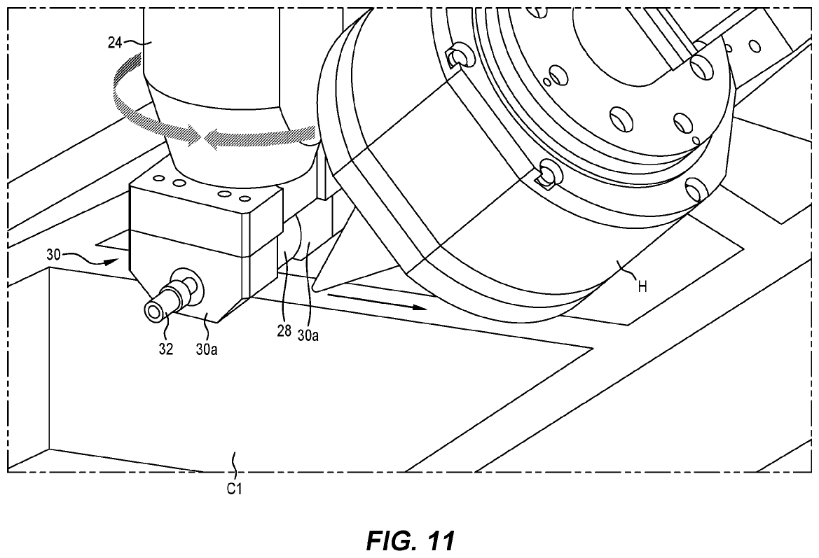

FIGS. 1 to 6 show an installation 10 including a housing 12 that defines an enclosure 12a, although to top cover is not shown in order to exhibit apparatus 14 according to the invention that is accommodated within the housing 12. Outside the housing 12, the installation 10 also includes ancillary equipment A1 to A6 that services or supplies the apparatus 14 to enable the production or repair by additive manufacturing of a component, shown as component C1 of one form in FIGS. 7 and 8, and as a different component C2 shown in the alternative arrangement of FIGS. 9 and 10. As can be seen more readily in FIGS. 7 and 8, and in the alternative of FIGS. 9 and 10, the apparatus 14 includes a support platform P on which a component C is built or repaired, a multi-axis robotic arm R that is mounted adjacent to the support platform P, and a direct metal deposition system illustrated only by a metal deposition head H that is carried by the robotic arm R above the platform P. While not shown, at least one heating element or plate may be provided under, or incorporated within, the substrate P to enable provision for heating of at least a region of platform P prior to or during the deposition and micro-forging/micro-rolling process. The temperature of platform P can vary with the material and size of the component. The heat elements or plates may be organized in such that some of them can be switched off if the given part of the platform P is not used in the process, such that with a platform can be 2 m long being used to manufacture or repair a component that is only 0.5 m long, heating for up to 1.5 m of the platform P can be disabled to save the energy.

Relative to a three-axis co-ordinate system having X- and Y-axes parallel to a horizontally extending plane, the support platform P is mounted for motorized movement relative to the X-Y plane, with the X- and Y-axes directed in the respective directions shown by arrows in FIG. 5, with the Z-axis perpendicular to that plane. The robotic arm R is operable to position the deposition head H relative to the platform P in that co-ordinate system. The apparatus further includes a CPU providing integration of CNC operation of the direct deposition system in depositing successive superimposed layers of metal to build or repair the component C. The CPU integrates movement of the support platform P relative to the horizontally extending X-Y plane and actuation of the robotic arm R to adjust the deposition head H parallel to the Z-axis and away from the support platform P after each layer is deposited, for repetitive deposition of metal in successive layers each superimposed on a preceding layer. The integration of operation is based on closed loop control with feedback monitoring whereby each successive deposited layer of metal replicates the form and dimensions of a respective successive slice of the component C, or part of a component C being repaired, in accordance with a 3D CAD description of the required end product component C.

With its top cover fitted, the housing 12 in which the apparatus 14 is contained, is either air-tight or is maintained at a slight overpressure, with a protective or inert atmosphere with a sufficiently low partial pressure of oxygen maintained in housing 12. Thus, the apparatus can be operated in an atmosphere substantially avoiding oxidation or a fire risk.

In FIGS. 1 to 6, the deposition head H may be that of any direct metal deposition system, whether it be a welding-based shaped metal deposition system, in which wire, or rod is melted to form a molten pool by an arc or a deposition system in which blown metal powder is melted by a laser or electron beam. Thus the deposition head H may for example be of a tungsten inert gas (TIG), a metal inert gas (MIG) or a system in which wire, or rod is melted utilizing plasma or inductive heating, or the head H may be a direct laser deposition (DLD) system as shown in FIGS. 7 and 8 and the variant of FIGS. 9 and 10.

The apparatus 14 include a rigid base B above which the support platform P is mounted and relative to which the support platform P is movable. The support platform is be movable linearly, such as parallel to one, but preferably each, of the X- and Y-axes. In the arrangement of FIGS. 1 to 8, the support platform P is mounted on an upper carriage 16 that is movable under the action of motor 16a linearly parallel to the X-axis, with the upper carriage mounted on a lower carriage 18 that is movable under the action of motor 18a linearly parallel to the Y-axis. In this arrangement, the support platform also may be motorized to be rotatable on an axis parallel to the Z-axis, such as in the manner of a turntable, as shown in the alternative arrangement of FIGS. 9 and 10 in which rotation is by drive motor Pa.

The apparatus 14 includes a unit F that enables in-situ forging/micro-rolling of each, or selected, layers of deposited metal prior to deposition of the next layer. The unit F is mounted on a column 20 that extends in the direction of the Z-axis to stand above and to one side of the support platform P. The column 20 fixed in relation to the base B above which the support platform P is positioned. Above the support platform P, the forging/micro-rolling unit F includes an adjustment arm 22 that extends laterally from the column 20, with the arm 22 adjustably mounted on the column 20 to enable movement of the arm 22 parallel to or in the direction of the Z-axis under the action of drive motor 22a. The forging/micro-rolling unit F includes a rod 24 depending below the arm 22 and, at the lower end of the rod, a forging/micro-rolling head 26 that includes a cylindrical forging/micro-rolling roller 28 mounted for rotation on an axis that is substantially parallel to the horizontally extending X-Y plane. The arrangement is such that, by varying the spacing of the adjustment arm 22 from the support platform, the rolling head is adjustable towards or away from the support platform P, parallel to or in the direction of the Z-axis. Thus, with use of the forging/micro-rolling unit F, the forging/micro-rolling head 26 is able to be positioned a distance from the support platform so that, as the support platform P is moved relative to the X-Y plane to advance newly deposited metal in a layer in the course of being formed, the forging/micro-rolling roller 28 of head 26 is able to apply controlled rolling pressure progressively along a line of deposited metal. A protective atmosphere, usually of argon, most preferably is introduced around the deposition head H and roller 28 to eliminate or minimize the oxidation of the material during deposition and in-situ forging/micro-rolling.

The deposition head H is relatively close to the forging/micro-rolling head 26. Consequently, a weld pool formed adjacent to the deposition head H, as well as the specific heat energy source for the chosen direct metal deposition system, will be correspondingly close to, and will tend to heat, the forging/micro-rolling roller 28. If left unchecked, the temperature of the roller 28 could increase progressively and lead to variation in the performance of the roller 28 in effecting forging/micro-rolling of the deposited metal. Accordingly, as illustrated in FIG. 11, the temperature of the forging/micro-rolling head 26 and of the roller 28 is controlled by circulation of a cooling fluid, most conveniently water, through the forging/micro-rolling head 26. For this, the roller 28 is hollow and secured at the lower end of the rod 24 of the unit F by being journaled in the lower ends of depending arms 30a of a yoke 30 of the forging/micro-rolling head 26 by which the roller 28 is secured to the lower end of the rod 24. As shown, the roller 28 has a respective end that is rotatable in a respective arm 30a of the yoke 30, with a respective connector 32 projecting from each end of the roller 28 to enable connection in a fluid flow line (not shown) to enable circulation of cooling fluid through the roller 28.

The base B together with the column 20 preferably form a relatively fixed or rigid to assist in the forging/micro-rolling unit F applying a strong forging and/or rolling force to successive layers of deposited metal. The arrangement is such that, with increasing aggregate height of deposited layers of metal above the support platform P, as a component C1,C2 is progressively built or repaired as each layer is deposited, the height of the forging/micro-rolling head 26 of the forging/micro-rolling unit F can increase correspondingly. This increase in height is achieved by adjustment of the height of the laterally extending adjustment arm 22 on the column 20. To enable this, the forging/micro-rolling unit F includes a drive motor 34 by which the adjustment arm 22 is movable along the column 20 for movement of the adjustment arm 22 in the direction of or parallel to the Z-axis. Operation of the drive motor 34 of the forging/micro-rolling unit F most preferably is by means of the CPU. Operation of the drive motor 34 may be to adjust the spacing of the forging/micro-rolling head 26 from the support platform P to achieve substantially uniform application of rolling pressure by the roller 28 of the forging/micro-rolling head 26 throughout the deposition of metal during the production or repair of a component C1,C2, or to vary the application of the pressure at selected stages of metal deposition during a production cycle.

The CPU operates the direct metal deposition system to deposit successive layers of metal by deposition head H by actuating the multi-axis robotic arm R to position the metal deposition head H, as required for metal deposition. Throughout a required cycle for the production or repair of a component, the robotic arm R may be actuated to maintain the deposition head H at fixed coordinates relative to the X- and Y-axes, while adjusting the position of the deposition head H parallel to the Z-axis, in synchronism with movement of the adjustment arm 22 of the forging/micro-rolling unit F in the direction of the Z-axis, to allow for the progressive build-up of metal as successive layers are deposited. For the production cycle, the CPU actuates a feed mechanism (not shown) providing a supply of feed metal to the deposition head H, whether the feed metal is wire, rod or metal powder, while the CPU also powers the deposition head H to melt the metal for deposition and progression of a weld pool.

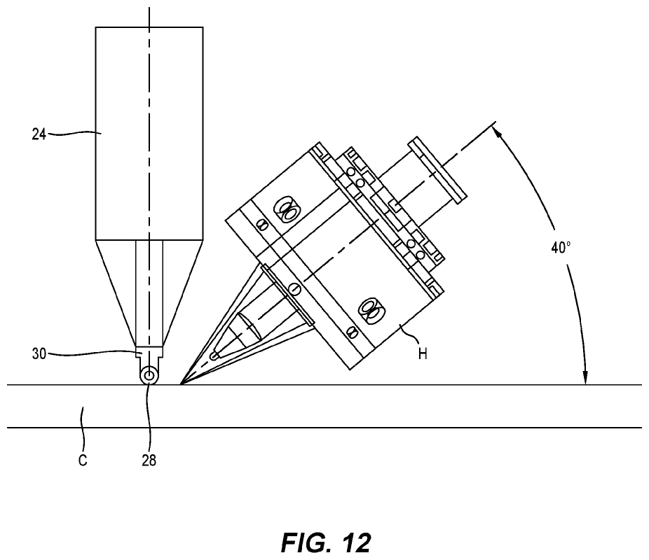

In positioning the deposition head H, the CPU can operate to maintain a weld pool in a deposition zone that is in close juxtaposition to the forging/micro-rolling head 26 of the forging/micro-rolling unit F. The arrangement preferably is such that the forging/micro-rolling head 26 follows closely after the deposition head H relative to the direction of metal deposition. Thus, as the support platform P is moved relative to the X-Y plane, the support platform P is moved under the deposition head H such the deposited metal is drawn towards the forging/micro-rolling head 26 and is progressively subjected to the action of the roller 28 of the forging/micro-rolling head 26. The axis of the roller 28 preferably is maintained perpendicular to a line along which the deposited metal is drawn towards the forging/micro-rolling head 26, such that the axis is substantially at right angles to a tangent to a deposition line, where the line is curved. The spacing between the deposition head H and the forging/micro-rolling head 26 can vary with the metal being deposited and, hence, the temperature prevailing in the weld pool, and also with the rapidity with which the metal solidifies sufficiently to be forged. The support platform P typically is of metal with which the metal being deposited can bond metallurgically, and the support platform and cooled preceding layers accordingly provide a heat sink assisting relatively rapid solidification of deposited metal. This enables the deposition head H to be in a desirable close juxtaposition to the forging/micro-rolling head 26, such as with a spacing between the forging/micro-rolling head 26 and the deposition head H of from about 10 to 60 mm, preferably of from about 15 to 40 mm, as shown in FIG. 12 illustrating the forging/micro-rolling head 26 and deposition work head H in position relative to a component C.

As indicated, the support platform P may move linearly, such as parallel to one of the X- and Y-axes. However, this essentially limits the apparatus 14 to being able to deposit metal in linear strips, such as in successive layers each comprising one linear strip or a series of laterally adjacent linear strips. It therefore is preferred that the support platform P is movable linearly parallel to each of the X- and Y-axes, as shown in the arrangement of FIGS. 7 and 8 which is well suited to the deposition of metal in the production or repair of a relatively simple article such as the frame comprising component C1. However, with a round article such as the hollow cylindrical component comprising component C2, the support platform P more preferably also rotatable on an axis parallel to the Z-axis in the manner of a turntable, as in the arrangement of FIGS. 9 and 10. However, for some applications, it can be sufficient for the support platform to be movable relative to the X-Y plane simply by the support platform P being rotatable.

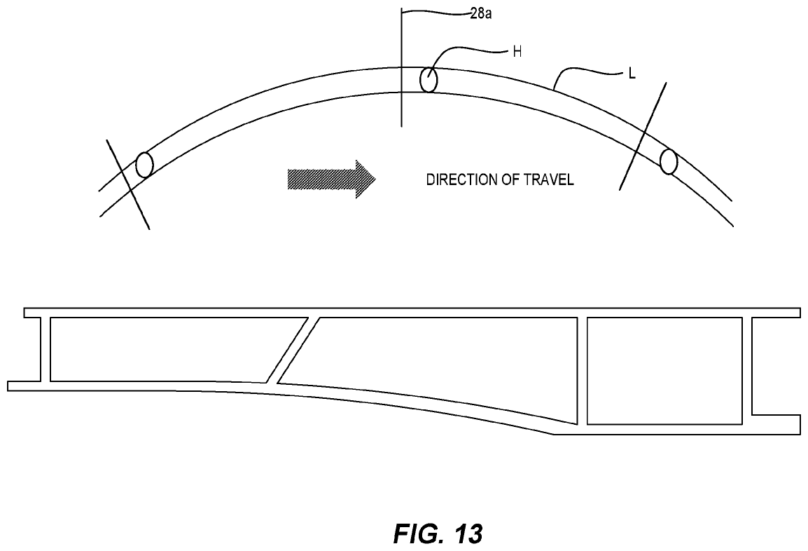

Whether the support platform P is movable parallel to each of the X- and Y-axes, or so movable and also rotatable on an axis parallel to the Z-axis, it is preferred that the CPU is able to cause the rod 24 of the forging/micro-rolling unit F to adjust by rotating on its upright axis and thereby enable the forging/micro-rollin head 26 to move so the horizontal axis of rotation of the roller 28 of the forging/micro-rolling head 26 swings. Thus, the rod 24 of the forging/micro-rolling unit F may have an upper end portion rotatably journaled in the adjustment arm 22, with the CPU operable to cause reversible rotation of the rod on an axis extending in the direction of or parallel to the Z-axis. The arrangement preferably is such that the forging/micro-rolling head 26 is able to sweep substantially parallel to the horizontally extending X-Y plane through an angle sufficient to maintain the roller 28 of the forging/micro-rolling head 26 in a substantially constant positioning relative to the deposition head H. As illustrated by the arrows extending circumferentially with respect to rod 24 in FIG. 11, the angle through which rod 24 is adjustable, and the angle though which the roller can sweep, may be up to about 180° to enable the forging/micro-rolling head 26 swing through about 90° to either side of an a line along which the roller 28 follows the deposition head H for linear deposition of metal, such that the axis of rotation of the roller 28 is able to extend radially with respect to a line of curved metal deposition. Thus, as illustrated by FIG. 13, the axis 28a of the roller 28 is able to be adjusted so that it is able to extend radially in tracking to follow a curved line L of deposited metal, in contrast to the non-tracking arrangement otherwise achieved if the roller is not able to so adjust.

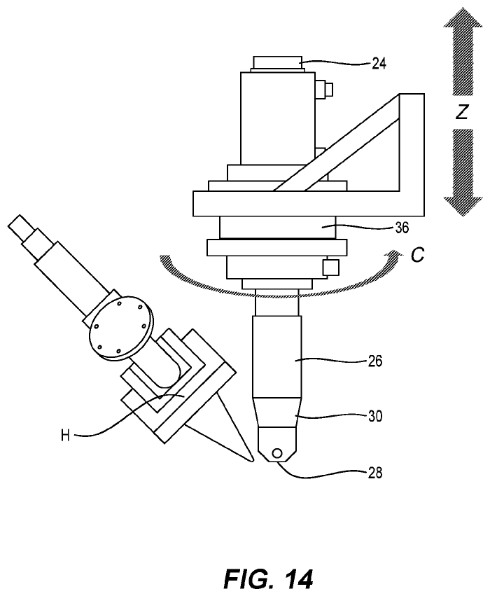

At least under stable operating conditions, the forging/micro-rolling unit F can enable substantially uniform rolling conditions through a production cycle of operation. However, the forging/micro-rolling unit F may have a form that enhances substantially uniform rolling conditions or that enables variation, as required, of the rolling conditions. For this, the forging/micro-rolling unit may incorporate a pressure sensing device 36, shown in FIG. 14, that monitors the pressure by which the roller 28 of the forging/micro-rolling head 26 is caused to bear against and roll the deposited metal. The device 36 allows the micro-forging/micro-rolling is carried out under a constant load or constant height position regardless the variation of the hardness of the possibly still semi-molten deposited metal. Thus, for example, the rod 24 of the forging/micro-rolling unit F, or the arm 22 in which the upper end of the rod 24 is mounted, may have a sensing device 36 comprising a load cell operable to measure the load applied to the deposited metal. The load can be displayed on a visual display of the apparatus, such as with the option of manual adjustment of the load, or the load may be monitored by the CPU, with the CPU operable to vary the load. In each case, the load may be varied by the motor 22a by which the arm 22 of the forging/micro-rolling unit F is adjustable along or parallel to the Z-axis.

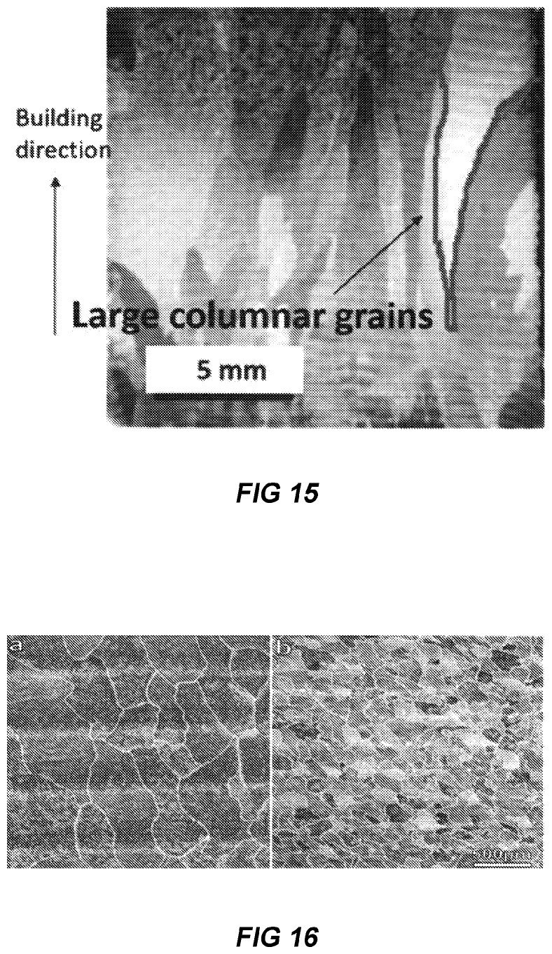

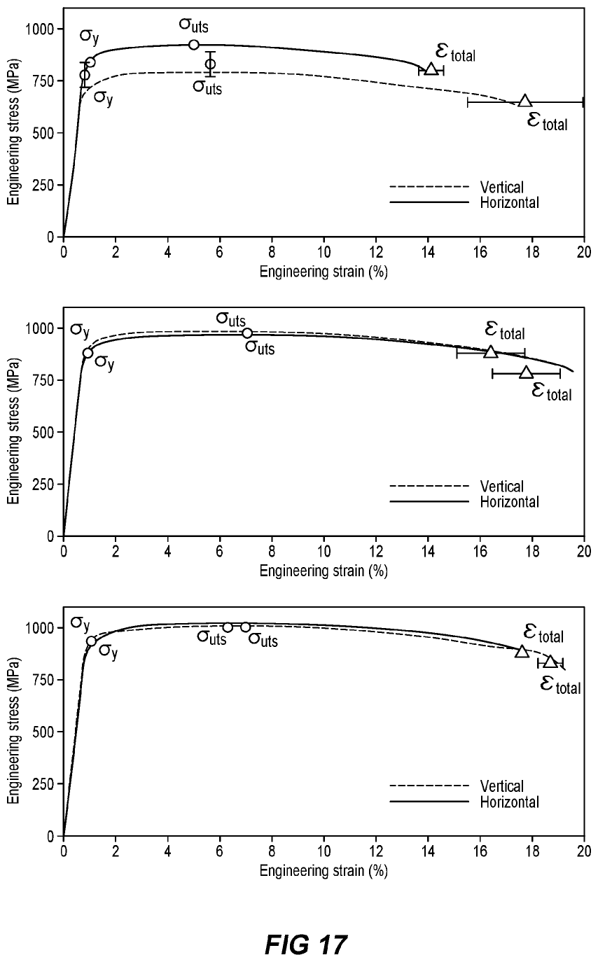

As previously indicated, Ti-6Al-4V is the most used titanium alloy in the world, and it has been widely selected for the fabrication of aircraft and other engineering components by DLD. However, this is despite Ti64 alloy tending to form large columnar grains along the building direction for components obtained by DLD, as clearly illustrated by FIG. 15. These large columnar grains lead to anisotropic mechanical properties, with pronounced differences along respective directions of the fabricated components. Also, tending to be an inherent issue limiting the application of DLD technology is the incidence of defects or voids which can form randomly in the DLD process. Large components, such as titanium components and parts in aircraft, usually are load-bearing components where fatigue life is critical, and defects/voids can lead to a dramatic reduction of fatigue life.

With application of the apparatus of the present invention, in-situ rolling of the semi-molten is incorporated along with application of the DLD process. The position of the forging/micro-rolling head 26 and, hence, of the roller 28 preferably is determined by a specific temperature range of required phases of the specific alloy chosen for direct metal deposition to achieve desired deformation. This results in adequate stored energy to achieve subsequent re-crystallisation of the deformed metal during a post heat treatment, thus enabling a refined and homogeneous microstructure to be achieved. For example, with direct metal deposition of Ti64 by DLD, the deposited alloy will have rapidly solidified but still be at a temperature in a range above the beta transus temperature, that is, above about 980C, at which temperature the deposited Ti64 alloy will comprise a single beta phase that is soft and easy to deform, and also easy to deform to close defects and voids resulting in the material during the deposition. The subsequent recystallisation heat treatment will be carried out below the beta transus, below about 980 C, within an alpha+beta two phase region so the material will transform into uniform, fine grained alpha+beta phases exhibiting outstanding tensile and fatigue properties characterising the thermally-mechanical-processed, forged or rolled microstructure. The compression of the soft beta phase material allows defects and voids to close and re-weld and thereby substantially eliminated, resulting in outstanding and consistent mechanical properties of the two-phase alloy, with very small scatter in fatigue properties.

Table 1 and FIG. 16 show a comparison of tensile properties of the unrolled and rolled samples: yield strength (YS), ultimate tensile strength (UTS) and total elongation of tensile samples (“V” and “H” represent vertical sample and horizontal sample, respectively, while standard deviation (SD) of three repetitive tensile testings is also included. Note that the samples subjected to rolling were rolled on each alternate layer, not on each layer, due to an apparatus limitation. Even with that limitation it can be seen at 50% deformation, the yield strength exceeds 924 MPa, more than 100 MPa higher than that of the un-rolled alloy; the elongation is 18-19%, with the maximum deviation of −0.7% whereas, in contrast, that of the un-rolled condition is 14-18%, with the maximum deviation of 2.2%.

TABLE 1
Comparison of Physical Properties

| | YS | UTS | Total elongation |
|---|---|---|---|
| | (MPa, SD) | (MPa, SD) | (%, SD) |
| Unrolled V | 770.9 ± 47.5 | 823.8 ± 56.0 | 17.7 ± 2.2 |
| Unrolled H | 840.8 ± 0.3 | 921.5 ± 1.7 | 14.1 ± 0.5 |
| Rolled 37.5% V | 896.0 ± 6.5 | 988.3 ± 0.1 | 16.3 ± 0.9 |
| Rolled 37.5% H | 886.2 ± 17.3 | 990.6 ± 11.9 | 17.7 ± 1.3 |
| Rolled 50% V | 924.0 ± 16.9 | 1010.7 ± 17.0 | 17.6 ± 0.2 |
| Rolled 50% H | 939.1 ± 4.1 | 1013.2 ± 6.5 | 18.7 ± 0.7 |

1. Additive manufacturing apparatus for the production or repair of a components, wherein the apparatus includes a support platform on which a component is built or repaired, with the support platform mounted for motorized movement relative to a horizontally extending X-Y plane; a direct metal deposition system having a metal deposition head carried above the platform by a multi-axis robotic arm that is mounted adjacent to the support platform, wherein the robotic arm is operable to move the deposition head relative to the platform in a three-axis co-ordinate system having X- and Y-axes parallel to the horizontally extending X-Y plane and a Z-axis perpendicular to the horizontally extending X-Y plane; and wherein the apparatus further includes a central processing unit (CPU) providing integration of computer numerical control (CNC) operation of the direct metal deposition system in depositing successive superimposed layers of metal to build or repair a component, with the central processing unit operable to integrate movement of the support platform relative to the horizontally extending X-Y plane and actuation of the robotic arm to adjust the deposition head parallel to the Z-axis and away from the support platform after each layer is deposited, as required for repetitive deposition of metal in successive layers each superimposed on a preceding layer, with the integration of operation in each case based on closed loop control with feedback monitoring whereby each successive deposited layer of metal replicates the form and dimensions of a respective successive slice of the component, or part of a component being repaired, in accordance with a 3D computer aided design (CAD) description of the component; and wherein the apparatus further includes a forging and/or micro-rolling (herein forging/micro-rolling) unit adapted to enable physical properties of deposited metal to be varied by in-situ forging of each, or selected, layers prior to deposition of the next layer; the forging/micro-rolling unit including:
(a) an adjustment member adjustably mounted above the support platform for motorized movement of the adjustment member parallel to or in the direction of the Z-axis; and
(b) a forging/micro-rolling head depending below the adjustment member and including:
(i) a depending member rotatable on an axis parallel to the Z-axis, and
(ii) a forging/micro-rolling roller mounted at a lower end of a depending member with the roller rotatable on an axis extending substantially parallel to the horizontally extending X-Y plane;
with the arrangement such that, by varying the spacing of the adjustment member from the support platform, the forging/micro-rolling head is adjustable towards or away from the support platform, parallel to or in the direction of the Z-axis whereby, with use of the forging/micro-rolling unit, the central processing unit (CPU) is operable to enable the forging/micro-rolling head to be positioned a distance from the support platform so that, as the support platform is moved relative to the X-Y plane to advance newly deposited metal in a layer in the course of being formed, the forging/micro-rolling head is operable to apply controlled rolling pressure progressively along a line of deposited metal and the depending member is rotated parallel to the Z-axis as required to maintain the axis of the roller substantially perpendicular to a linear line of deposited metal or substantially at right angles to a tangent to a curved line of deposited metal.

2. The apparatus of claim 1, wherein the apparatus is contained within a housing that is either air-tight or maintained at a slight overpressure whereby the apparatus can operate in a controlled protective or inert atmosphere, or at least an atmosphere with a sufficiently low partial pressure of oxygen minimizing oxidation or fire risk.

3. The apparatus of claim 1, wherein the direct metal deposition system is a welding-based shaped metal deposition system, in which wire, or rod is melted to form a molten pool by an arc, such as a tungsten inert gas (TIG), metal inert gas (MIG), or other systems in which wire, or rod is melted utilizing plasma or inductive heating.

4. The apparatus of claim 1, wherein the direct metal deposition system is a deposition system in which blown metal powder is melted by an electromagnetic beam, such as a laser or electron beam, with direct laser deposition (DLD) being preferred.

5. The apparatus of claim 1, further including a basal structure above which the support platform is mounted and relative to which the support platform is movable linearly, such as parallel to one of the X- and Y-axes and motorized to be rotatable on an axis parallel to the Z-axis, such as in the manner of a turntable.

6. The apparatus of claim 1, further including a basal structure above which the support platform is mounted and relative to which the support platform is movable by being mounted on a motorized upper carriage that is movable linearly parallel to one of the X- and Y-axes, with the upper carriage mounted on a motorized lower carriage that is movable linearly parallel to the other one of the X and Y-axes, with the support platform optionally being motorized to be rotatable on an axis parallel to the Z-axis, such as in the manner of a turntable.

7. The apparatus of claim 1, wherein the apparatus further includes a column that extends in the direction of the Z-axis to stand above and to one side of the support platform, with the column fixed in relation to a rigid base above which the support platform is positioned; and wherein the adjustment member comprises an adjustment arm that extends laterally from the column, with the adjustment arm adjustably mounted on the column to enable motorized movement of the adjustment arm parallel to or in the direction of the Z-axis.

8. The apparatus of claim 1, wherein the forging/micro-rolling head comprises a hollow roller that is secured by being journaled in the lower ends of depending arms of a yoke, with a respective connector projecting form the end of each stub axle to enable the roller to be connected in a fluid flow line to enable circulation of cooling fluid through the roller.

9. The apparatus of claim 8, wherein the forging/micro-rolling unit includes a rod depending below the adjustment arm with the yoke at the lower end of the rod.

10. The apparatus of claim 1, wherein the deposition head is near to the forging/micro-rolling head, such as from about 10 to 60 mm, preferably of from about 15 to 40 mm.

11. The apparatus of claim 1, wherein the temperature of the forging/micro-rolling head is controllable by circulation of a cooling fluid, most conveniently water, through the forging/micro-rolling head.

12. The apparatus of claim 11, wherein the forging/micro-rolling head comprises a hollow roller that is secured at the lower end of the rod of the forging unit by being journaled in the lower ends of depending arms of a yoke mounted at the lower end of the rod, with a respective connector projecting form the end of each stub axle to enable the roller to be connected in a fluid flow line to enable circulation of cooling fluid through the roller.

13. The apparatus of claim 8, wherein the forging/micro-rolling head has a roller made of metal that, at the prevailing temperature at which forging/micro-rolling is to be conducted, is compatible with the metal being deposited and to be rolled with the metal of the roller optionally having a composition the same as, or like, that being deposited, a metal having a hardness value greater than that of the metal being deposited.

14. The apparatus of claim 8, wherein the forging/micro-rolling head has a roller of a suitable ceramic that is sufficiently thermally conductive as to be able to be used, if necessary, with cooling, at a sufficiently stable temperature, with suitable ceramics including silicon carbide, tungsten carbide and boron nitride.

15. The apparatus of claim 8, wherein the overall structure formed by the base above which the support platform is positioned, and by the column, is relatively fixed or rigid and wherein, with increasing aggregate height of deposited layers of metal above the support platform, the height of the rolling head of the forging/micro-rolling unit is able to increase correspondingly by adjustment of the height of the laterally extending adjustment arm on the column; and wherein the forging/micro-rolling unit includes a drive system by which the adjustment arm is movable on the column for movement of the adjustment arm in the direction of or parallel to the Z-axis.

16. The apparatus of claim 15, wherein operation of the drive system of the forging/micro-rolling unit is by means of the central control unit and such as to adjust the spacing of the forging/micro-rolling head from the support platform to achieve substantially uniform application of pressure by the rolling/micro-rolling head throughout the deposition of metal during the production or repair of a component, or to vary the application of the pressure at selected stages of metal deposition during a production cycle.

17. The apparatus of claim 8, wherein the axis of the roller is adjustable to enable the axis of the roller to be maintained perpendicular to a line along which the deposited metal is drawn towards the forging/micro-rolling head, such that the axis is substantially at right angles to a tangent where the line is curved.

18. The apparatus of claim 17, wherein the rod of the forging/micro-rolling unit has an upper end portion rotatably journaled in the adjustment arm, with the central control unit operable to cause reversible rotation of the rod on an axis extending in the direction of or parallel to the Z-axis whereby the forging/micro-rolling head is able to sweep substantially parallel to the horizontally extending X-Y plane through an angle sufficient to maintain the roller of the forging/micro-rolling head in a substantially constant positioning relative to the deposition head.

19. The apparatus of claim 18, wherein the angle may be up to about 180° to enable the forging/micro-rolling head swing about 90° to either side of a line along which the roller follows the deposition head for linear deposition of metal, such that the axis of rotation of the roller is able to extend radially with respect to a line of curved metal deposition.

20. The apparatus of claim 8, wherein the forging/micro-rolling unit incorporates a pressure sensing device, such as a load cell, that monitors the pressure by which the forging/micro-rolling head is caused to bear against and roll the deposited metal.

21. The apparatus of claim 1, wherein the central control unit operates the direct metal deposition system by actuating the multi-axis robotic arm to position the metal deposition head as required for metal deposition by actuation of the robotic arm maintain the deposition head at fixed coordinates relative to the X- and Y-axes, while adjusting the position of the deposition head parallel to the Z-axis, in synchronism with movement of the adjustment arm in the direction of the Z-axis, to allow for the progressive build-up of metal as successive layers are deposited.

22. The apparatus of claim 1, wherein the control unit actuates a feed mechanism providing a supply of feed metal to the deposition head, whether the feed metal is wire, rod or metal powder, and control unit also powers the deposition head to melt the metal for deposition and progression of a weld pool.
